(19) United States
(12) Patent Application Publication
(10) Pub. No.: US 2026/0208400 A1
(43) Pub. Date: Jul. 23, 2026

(54) Method for cleaning molding tools for molding fibrous materials and molding tool

(71) Applicant: Kiefel GmbH, Freilassing (DE)

(72) Inventors: Richard Hagenauer, Saaldorf-Surheim (DE); Josef Rehrl, Teisendorf (DE); Hubert Rehrl, Teisendorf (DE)

(21) Appl. No.: 19/454,804

(22) Filed: Jan. 21, 2026

(30) Foreign Application Priority Data
Jan. 23, 2025 (DE) 10 2025 102 503.7

(51) Int. Cl. B29C 33/72; B29C 33/02

(52) U.S. Cl. CPC B29C 33/72; B29C 33/02

(57) ABSTRACT

A method for cleaning molding tools for molding fibrous materials and a molding tool are described. The method includes introducing a liquid medium to the molding tool where the molding tool has openings in at least one region of a shaping surface. The openings are connected to channels for discharging water vapor exiting during a molding process under pressure and heat input. The openings and channels for discharging water vapor are provided in a discharge direction out of the molding tool. For cleaning the openings and channels, a medium in liquid form is introduced into at least one channel of the molding tool counter to the discharge direction when the molding tool has a minimum temperature. The introduced liquid medium changes into a gaseous state by contact with the molding tool and exits from the channels and openings counter to the discharge direction.

### PRIORITY CLAIM

The present application claims priority under 35 U.S.C. § 119 to German Patent Application No. DE 10 2025 102 503.7, filed January 23, 2025, the disclosure of which is incorporated by reference herein in its entirety.

### TECHNICAL FIELD

A method for cleaning molding tools for molding fibrous materials and a molding tool are described.

### BACKGROUND

Fiber-containing materials are increasingly used, for example, to produce packaging for food (e.g., trays, capsules, boxes, etc.) and consumer goods (e.g., electronic devices, etc.) as well as beverage containers. Everyday items, such as disposable cutlery and tableware, are also made from fiber-containing material. Fiber- containing materials contain natural fibers or artificial fibers. Recently, fiber- containing material is increasingly used that has or is made of natural fibers which can be obtained, for example, from renewable raw materials or waste paper. The natural fibers are mixed in a so-called pulp with water and optionally further additives, such as starch. Additives can also have an effect on color, barrier properties and mechanical properties. This pulp can have a proportion of natural fibers of, for example, 0.1 to 10 wt.%. The proportion of natural fibers varies depending on the method used for the production of packaging etc. and the product properties of the product to be produced.

The production of fiber-containing products from a pulp generally takes place in a plurality of work steps. For this purpose, a fiber processing device has a plurality of stations. In a suction station, fibers can be suctioned into a suction cavity of a suction tool, for example, because of which a preform is molded or formed. For this purpose, the pulp is provided in a pulp supply, and the suction tool is at least partially immersed in the pulp with at least one suction cavity whose geometry substantially corresponds to the product to be produced. During the immersion, suction takes place via openings in the suction cavity, which are connected to a corresponding suction device, where fibers from the pulp accumulate on the surface of the suction cavity. The suctioned fibers or a preform can subsequently be brought into a pre-pressing tool via the suction tool, and the preform is pre-pressed. For this purpose, for example, it is possible to use elastic mold bodies which are inflated in order to press and, in the process, exert pressure on the preforms. During this pre-pressing process, the fibers in the preform are compressed and the water content of the preform is reduced. Alternatively, preforms can be provided by means of scooping, where a scoop tool is immersed in the pulp and during startup fibers are deposited on molded parts of the scoop tool.

After this, preforms are pressed in a hot pressing device to form finished molded parts. This is the final step in molding molded parts. In this process, preforms are inserted into a hot press tool which has, for example, a lower tool half and an upper tool half which are heated. In the hot press tool, the preforms are pressed in a cavity under heat input, where residual moisture is discharged by the pressure and heat, such that the moisture content of the preforms is reduced from approximately 60 wt.% before hot pressing to, for example, 5-10 wt.% after hot pressing and a bonding of the fibers by hydrogen bonds is achieved. The water vapor produced during hot pressing is suctioned off during the hot pressing via openings in the cavities and channels in the hot press tool.

A production method and a fiber processing device are known, for example, from DE 102019127562 A1, which is incorporated by reference as if fully set forth herein.

In the hot press tools or the molding tools with mold bodies that have a shaping surface for pressing the fibrous material along with openings in the shaping surface for suctioning off water vapor and channels connected to the openings, the channels and openings regularly become contaminated since, during discharging of water vapor (for example, suctioning off) during pressing, fibrous material is also suctioned along. This thereby leads to deposition of small fibrous materials (e.g., MFC) and constituents of the pulp-water (e.g., lime, additives, etc.). The more the channels and openings become contaminated, the worse water vapor can be discharged, such that the quality of the molded parts to be produced steadily decreases with increasing contamination. If openings or channels are clogged, water vapor can no longer be discharged, for example, such that regions of molded parts exhibit a comparatively high moisture content or cracks and other defects.

The contamination of molding tools and mold bodies during processing of fibrous materials for producing molded parts is a significant cause of molded parts not exhibiting the desired properties. For this reason, various attempts have already been undertaken to provide cleaning of molding tools or mold bodies.

WO 2022/072555 A1, which is incorporated by reference as if fully set forth herein, describes a cleaning method in which compressed air is blown through the openings of a tool after each cycle (molding step). Since cleaning by means of compressed air is not sufficient, it is additionally proposed to rinse the tool with clean water at regular intervals. For this purpose, the tool must be cooled and subsequently removed. Only then is rinsing with water possible. However, such cleaning is highly time-consuming. In addition, the downtime of a system increases, since removal and installation of the tool along with the rinsing with clear water alone require a very high time expenditure.

Furthermore, molding tools are currently being removed and the clogged openings and channels are being mechanically cleaned. Such cleaning is time- consuming and is also highly difficult, because the openings and channels have very small diameters.

Overall, the known cleaning measures are very complex, costly and cannot provide sufficient cleaning.

### SUMMARY OF EMBODIMENTS

### OBJECT

In contrast, an object includes specifying a solution for cleaning molding tools for producing molded parts from fibrous material, which reliably loosens and discharges contaminants from molding tools, where the downtime of molding tools is reduced to a minimum.

### SOLUTION

The object stated above is achieved by a method for cleaning molding tools for molding fibrous materials, where the molding tool has openings in at least one region of a shaping surface that are connected to channels for discharging water vapor exiting during a molding process under pressure and heat input, where the openings and channels for discharging water vapor are provided in a discharge direction out of the molding tool, where for cleaning the openings and channels a medium in liquid form is introduced into at least one channel of the molding tool counter to the discharge direction when the molding tool has a minimum temperature, where the introduced liquid medium changes into a gaseous state by contact with the molding tool and exits from the channels and openings counter to the discharge direction.

In the method, cleaning is carried out by the introduced medium, for example water, that evaporates by contact with a surface of at least one channel, where the resulting steam exits from the channels and openings counter to the discharge direction. Water in the gaseous aggregate state is usually referred to as water vapor. In the process, impurities and deposits are entrained by the water vapor, for example, and discharged from the molding tool. Advantageously, the molding tool does not need to cool down in order to be cleaned with a liquid medium. Rather, the existing heat of the molding tool is used to evaporate the cleaning medium. In addition, the water or the steam can also dissolve impurities. The dissolved impurities can then be discharged from the molding tool.

Instead of water, other media can also be used, where, below, the method and the advantages are described for water as the cleaning medium. Due to the preferably abrupt evaporation, a strong change in volume of the medium occurs. The energy supplied via the hot molding tool increases the internal energy of the medium. The increase in energy and the change in volume are used here in order to tear loose contamination and deposits and to discharge them from the molding tool.

The direction of the water vapor can be controlled, for example, by valves or the like, where the water vapor can escape, after introduction of the water and evaporation, only via the openings of the shaping surface of the molding tool. For introducing water or a medium, the molding tool can have a connector that is connected, for example, to a conveying device for introducing the medium into the one channel.

Since abrupt evaporation occurs and the water vapor likewise exits quickly for cleaning, the cleaning process can be carried out quickly and allows for a complete cleaning. Thus, cleaning can take less time, for example, than the molding time for molding fibrous materials in the molding tool. Furthermore, cleaning requires no removal, no cooling times and no attachments or add-ons for the molding tool (for example, cleaning devices).

The amount of introduced medium (for example, water) can be determined, for example, in accordance with molding-related cooling of the molding tool during pressing of fibrous material, in order to prevent the molding tool from cooling, by the introduced medium, beyond a customary extent. During molding and pressing of fibrous materials, the shaping surface and the molding tool cool down due to the energy introduced into the fibrous material. This is determined by the amount of fibrous material, its moisture content and the pressing duration. If the thermal energy required for the cleaning substantially corresponds to the thermal energy discharged during a molding operation, the molding tool does not cool down during the cleaning process in a manner that differs from the customary temperature fluctuation of the molding tool during molding. Thus, after the cleaning process, production of molded parts can continue directly.

Thus, a simple, cost-effective and efficient cleaning is made possible.

In further embodiments, the minimum temperature can be in a temperature range of 90 - 300 °C, preferably 150 - 250 °C, in particular 180 - 230 °C.

In further embodiments, process heat of the molding process for molding fibrous materials can be used for the change of the aggregate state of the liquid medium.

In further embodiments, the minimum temperature can be provided by a heating device for the molding tool for molding, where the heating device is essential for molding and therefore does not constitute an additional unit for the cleaning process.

In other embodiments, water can be introduced as the liquid medium.

In further embodiments, the liquid medium can be introduced under a pressure of 1 to 200 bar, preferably 3 to 20 bar.

In other embodiments, the liquid medium can be introduced in pulses. This makes it possible, during a cleaning step, to exert multiple pressure changes on contaminants in the channels and openings of the molding tool, because the steam pressure of the water vapor can increase and/or vary with each pulse.

In further embodiments, the liquid can be supplied in a temperature range of 5 - 50 °C, preferably at ambient temperature.

In further embodiments, the liquid can include at least two different constituents. For example, cleaning additives can be admixed with the water. This can further support the dissolution of impurities.

In further embodiments, the molding tool can have at least two mold halves that are movable relative to one another, and the mold halves can in each case have at least one shaping surface that, in the closed state, forms a cavity, where the introduction of the liquid is carried out when the mold halves are open. In this way, it is prevented that the molding tool or a molded part is damaged by water vapor generated abruptly.

In further embodiments, the introduction of the liquid can be carried out after the molding of fibrous material in the cavity. In the process, a molded part molded from the fibrous material can rest on a shaping surface. The water vapor exiting from the molding tool together with impurities can itself be deposited on the molded part. Depending on a degree of contamination and the contaminants adhering to the molded part, such a molded part may be discarded as scrap or - if only minor deposits are present - further processed. The degree of contamination can be assessed using various criteria. For example, this can be assessed based on optical criteria (visibility), surface quality, adhesion of the contamination, effects (e.g., health effects upon consumption), etc.

In further embodiments, in a cleaning cycle after molding a fibrous material into a molded part, the molding tool can initially be opened by relative displacement of the two mold halves, and the molded part can be held by suction via the openings and channels of a first mold half, and cleaning by the gaseous medium can be carried out via the openings and channels of a second mold half, and the molding tool can subsequently be closed again, where the molded part is transferred by suction to the second molded part half, and the molding tool is subsequently opened, where cleaning of the channels and openings of the first molded part half is then carried out via the gaseous medium. In this way, both mold halves can be cleaned sequentially, where, for this purpose, a transfer of a molded molded part is carried out such that exiting contaminants are deposited on opposite sides of the molded part.

In further embodiments, cleaning can be carried out alternately via the openings and channels of the two mutually movable mold halves. For example, a medium can be alternately introduced into the mold halves several times.

In further embodiments, the introduction of the liquid medium can be carried out regularly, where, for example, automatic cleaning occurs after a definable number of molding operations. In further embodiments, additionally or alternatively, cleaning can be carried out based on detected contamination. The contamination can, for example, be detected by pressure changes during suction of water vapor during pressing. In further embodiments, a temperature of the molding tool can additionally be detected, where a temperature change occurs when openings and/or channels become clogged, where this leads to altered steam discharge and, ultimately, to altered thermal influence on the molding tool. In further embodiments, additionally or alternatively, moisture of molded molded parts can be detected. In still further embodiments, additionally or alternatively, a visual inspection can be carried out, for example via a system with an image detection and evaluation unit.

In further embodiments, the molding tool can have at least one tool body and at least one mold body connected to the tool body, where the at least one mold body has a shaping surface with openings and channels for discharging water vapor, and where the liquid medium is introduced into at least one collecting channel of the tool body that is connected to the channels of the at least one mold body. The medium, in particular the water vapor, can flow from the at least one collecting channel in the tool body into the channels of the at least one mold body. In further embodiments, the water vapor can be supplied to a plurality of mold bodies. With a suitable configuration of collecting channels and introduction of liquid media at at least one point, water vapor can, for example, distribute itself starting from the center of a tool body. The water vapor can then exit from the middle of the tool body to the outside.

In further embodiments, the tool body can be heated, where the heating is provided for the temperature required for molding fibrous material. The thermal energy present in the molding tool is advantageously used for cleaning the molding tool, without impairment of the molding process occurring.

The above-mentioned object is also achieved by a molding tool for molding molded parts from fibrous material, where the molding tool has two mold halves that are movable relative to one another, where the mold halves in each case have at least one mold body with a shaping surface, and the shaping surface has openings that are connected to channels in the mold body, and where the molding tool has a device for direct or indirect introduction of a liquid medium into the channels of at least one mold body.

Direct introduction can be achieved by introducing the material into a mold body, and indirect introduction can be achieved by introducing a liquid medium (for example, water). The device can, for example, be designed as a lance that is inserted into a (collecting) channel of a tool body or, in further embodiments, is inserted for introducing the medium. The medium can then be introduced at at least one suitable point, from where the evaporated medium can, for example, spread and distribute itself evenly.

In further embodiments, the device can include valves that control the spread of the water vapor, such that, for example, water vapor can flow from at least one collecting channel in a tool body only in the direction of mold bodies. This prevents water vapor, for example, from exiting via openings in the tool body for pressure equalization and/or supply/discharge of process air during a molding process. Accordingly, no pressure drop occurs due to escape of water vapor at such auxiliary openings that are not openings at shaping surfaces.

Further features, embodiments and advantages result from the following illustration of exemplary embodiments with reference to the figures.

### BRIEF DESCRIPTION OF THE FIGURES

In the figures:

FIG. 1 is a schematic representation of a molding tool for producing molded parts from a fibrous material;

FIG. 2 is a schematic representation of one embodiment of a mold body and a tool body of a molding tool;

FIG. 3 is a further schematic representation of the embodiment of a mold body and a tool body of a molding tool; and

FIG. 4 is a schematic representation of a method for molding molded parts and cleaning a molding tool.

### DETAILED DESCRIPTION OF EXEMPLARY EMBODIMENTS

Various embodiments of the technical teaching described herein are shown below with reference to the figures. Identical reference signs are used in the figure description for identical components, parts and processes. Components, parts and processes that are not substantial to the technical teachings disclosed herein or that are obvious to a person skilled in the art are not explicitly reproduced. Features specified in the singular also encompass the plural unless explicitly stated otherwise. This applies in particular to statements such as "a" or "one.

The production of molded parts 200 from a fibrous material in a so-called wet process is carried out in several steps. A pulp is provided for this purpose. The pulp is an aqueous solution containing fibers. The fiber content can be, for example, 0.1-5 wt.%. The fibers can be or include natural fibers, e.g., cellulose fibers, MFC, or fibers from a fibrous source material (e.g., waste paper), etc. In addition, additives and admixtures, such as starch, chemical additives, wax, etc., can be supplied to a pulp in order to influence the properties (e.g., barrier properties) of the molded parts or products to be produced and processability. Since a fibrous pulp with natural fibers can be used as the starting material for the molded parts 200, after being used, the molded parts 200 produced from them can themselves once again be used as a starting material for producing molded parts 200 or other products, or they can be composted, because they can usually be completely decomposed and do not contain any dangerous substances that are harmful to the environment.

After the pulp has been provided, the fibers are molded from the pulp by scooping or suction on a deposition surface of a cavity. For example, fibers can be suctioned via a suction tool with suction cavities, where the deposition surface has a mesh-like surface, such that fibers can accumulate thereon and water that is also suctioned is discharged. Suction cavities can substantially already have the shape of the molded parts to be produced.

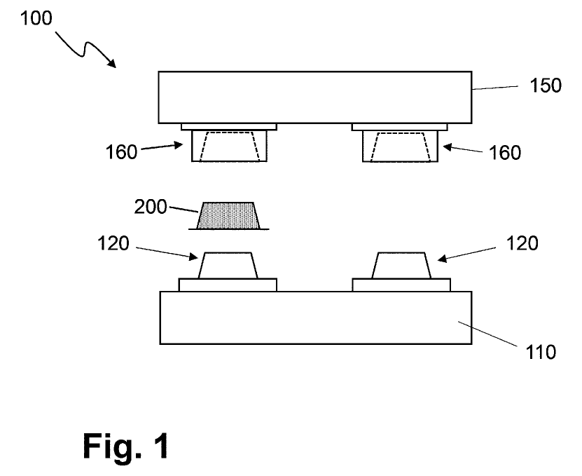

The suctioned fibers can subsequently be mechanically pre-pressed further, for example, in a pre-pressing station with inflatable membranes. Subsequently, the preforms preformed from the fibers are pressed in a so-called hot press, which can have a molding tool 100 shown in FIG. 1.

The molding tool 100 shown in FIG. 1 serves for producing molded parts 200 from a fibrous material and has a first mold half with a first tool body 110 and a second mold half with a second tool body 150. Mold bodies 120, 160 are arranged on the mutually facing faces of the tool bodies 110, 150. In further embodiments, a plurality of mold bodies 120, 160 can be provided, where FIG. 1 shows only two mold bodies 120, 160 for illustration purposes. FIG. 1 shows the molding tool 100 in an open state, where the tool bodies 110, 150 with the mold bodies 120, 160 are moved away from one another relative to one another. In this state, preforms can be placed on a shaping surface 124 of the mold bodies 120 or inserted into the mold bodies 160. After introduction of the preforms, the molding tool 100 is moved toward one another by relative displacement of the tool bodies 110, 150, where the preforms are pressed between the shaping surfaces of the mold bodies 120, 160 in a mold cavity. The mold bodies 120, 160 can also be heated, such that under pressure and thermal influence bonding of the fibers and final molding of molded parts 200 is carried out. For this purpose, the tool bodies 110, 150 and the mold bodies 120, 160 are made of a suitable thermally conductive material (for example, aluminum).

The heating of the mold bodies 120, 160 can be carried out directly via heating elements in the mold bodies 120, 160 or indirectly via heating elements in the tool bodies 110, 150.

After molding of the mold bodies 200, these are removed from the molding tool 100 and, for example, supplied to post-processing.

During pressing of moist fibrous material (moisture content > 50 wt.%) at high temperatures (for example, 160 - 280 °C), water vapor is produced, which is discharged via openings 126 and channels 127 in the mold bodies 120 and at least one collecting channel 112 in the tool body 110. The water vapor can, for example, be discharged via a negative pressure (vacuum) or a conveying device (e.g., fan). In further embodiments, the tool body 150 and the molded parts 160 can also have openings 126 and channels 127 as well as at least one collecting channel 112.

This also results in the discharge of the smallest fiber particles, which are deposited at the openings 126 and channels 127. In addition, solids bound in the water vapor (e.g., lime scale) can be deposited. Therefore, during pressing in molding tools 100, there is increasing contamination, in particular of the openings 126 and channels 127, as a result of which the cross section for discharging water vapor increasingly decreases. This can lead to a complete blockage. The smaller the amount of discharged water vapor, the more strongly the shaping surfaces 124 also become contaminated. Furthermore, sufficient drying of the molded parts 200 no longer occurs. Further, high pressure can prevail in the mold cavity due to water vapor that is not discharged or not sufficiently discharged, which can damage the molded parts at least locally.

Furthermore, contamination and clogging of collecting channels 112 can also occur.

In order to prevent or eliminate contamination, it is necessary to clean the molding tool 100 and, in particular, the channels 127 and openings 126 regularly. In the process, the mold bodies 120 are generally formed as a block 122. The openings 126 and channels 127 can, for example, be introduced into the block 122 by drilling. The openings 126 and channels 127 also have a small diameter, which makes cleaning more difficult, but is necessary in order to limit the discharge of fibrous material via the openings 126. In addition, protruding elevations occur in the region of the openings 126 on pressed molded parts 200, such that the openings 126 are kept correspondingly small. In particular with regard to the formation of the openings 126 and channels 127, the known cleaning measures as described at the outset are disadvantageous.

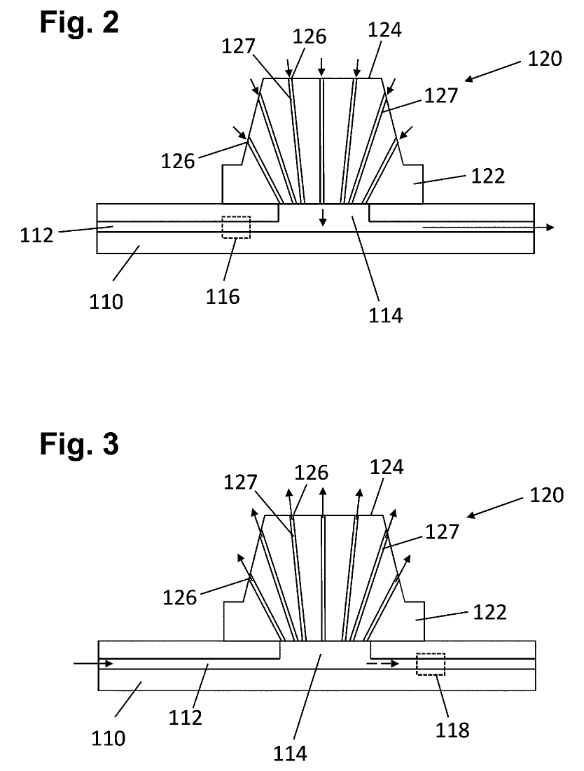

FIG. 2 shows a schematic representation of an embodiment of a mold body 120 and a tool body 110 of a molding tool 100. In FIG. 2, the discharge of water vapor during a molding process is shown schematically. During molding, water vapor exiting is discharged via openings 126 at the shaping surface 124 and channels 127 in the mold body 120, for example by suction. The mold body 120 is connected to the tool body 110 by screws (not shown) or the like. The channels 127 of the mold body 120 open into an inlet region 114 of a collecting channel 112. In the exemplary embodiment shown, the collecting channel 112 has two inlets and/or outlets so that a liquid medium for cleaning can be introduced and water vapor generated during pressing can be discharged. In FIG. 2, a valve 116 is shown in a portion of the collecting channel 112. This portion of the collecting line serves for introducing liquid medium for cleaning. When discharging water vapor during pressing from the mold cavity between the shaping surfaces 124 of a pair of mold bodies 120 and 160 (not shown), the water vapor is discharged via a conveying device (e.g., a fan) or a vacuum chamber. In further embodiments, the valve 116 can be omitted or a valve 116 can be partially opened so that pressure equalization or inflow of, for example, ambient air is possible when discharging water vapor. In particular, when discharging water vapor during pressing from the mold cavity, the flow direction (discharge direction) of the water vapor is specified by the conveying device or vacuum chamber.

A conveying device or vacuum chamber can additionally serve to hold preforms and molded parts 200 by negative pressure during the molding process and during transfer. For this purpose, a corresponding negative pressure can be generated via one of the opposing mold bodies 120, 160.

After molding molded parts 200 in the molding tool 100, cleaning of the molding tool 100 is carried out at determinable intervals (depending on the degree of contamination) or at specified intervals (for example, after 1000 molding operations).

In FIG. 3, cleaning by introducing a liquid medium for cleaning the mold body 120 and its channels 127 and openings 126 is shown schematically. For this purpose, a liquid medium is introduced into the collecting channel 112. Water, for example, can be used as the liquid medium. As a result, it is not necessary to use expensive and aggressive media that can damage the channel structure and surfaces of the tool body 110 and the mold bodies 120. In further embodiments, cleaning additives can be admixed with the water. Cleaning is carried out immediately after a molding process or when the molding tool 100 or the tool bodies 110, 150 and/or the mold bodies 120, 160 have reached a minimum temperature. The minimum temperature preferably corresponds to the molding temperature of the molding tool 100 required for molding fibrous material. The minimum temperature can be, for example, 160-280 °C. Therefore, when water is introduced as a cleaning medium, it evaporates abruptly as soon as the water comes into contact with hot components of the molding tool 100, for example the wall of the collecting channel 112. This steam expands abruptly and flows counter to the discharge direction through the channels 127 and openings 126. When water evaporates, a strong change in volume occurs, as a result of which high pressure is created by the medium, which leads to the loosening of contaminants when flowing through the channels 127 and openings 126. The water and/or the steam can additionally dissolve impurities.

In order to control the spread of the steam for cleaning, at least one valve 118 can be provided, which prevents the steam from escaping away from the openings 126. As a result, the steam can exit only through the openings 126 of mold bodies 120 (or mold bodies 160). Via the at least one collecting channel 112, steam can flow to further inlet regions 114 and channels 127 of mold bodies 120, such that all mold bodies 120 of a molded part half or of a molding tool 100 can be cleaned in a single cleaning operation. The water can be introduced at only one point in a collecting channel 112 or at a plurality of points in one or more collecting channels 112. In further embodiments, water can also be introduced directly into channels 127 of mold bodies 120. The amount of water used for cleaning can vary. For example, the amount of water and the heat withdrawn from the molding tool 100 required to evaporate the water can substantially correspond to the amount discharged during the pressing of fibrous material. In the process, the thermal energy discharged from the molding tool 100 during pressing can be substantially the same as that during cleaning. As a result, it is possible to start cleaning immediately after a molding operation and to continue molding immediately after cleaning.

For cleaning, the molding tool 100 can be opened and a previously molded molded part 200 (or a preform) can remain on the shaping surface 124 of the mold body 120, 160 to be cleaned. The steam exiting during cleaning and the loosened contaminants then adhere to a surface of the molded part 200 or preform and do not damage or contaminate the molding tool 100. In further embodiments, the molding tool 100 can be opened only slightly, where a gap (for example 5 - 50 mm) exists between the molded part halves. This is advantageous when cleaning "upper" mold bodies 160, because it is not possible to hold molded parts 200 by suction via the openings 126 and channels 127 while simultaneously cleaning by outflow of steam in the opposite direction via the channels 127 and openings 126. Therefore, molded parts 200 can remain on opposite, "lower" mold bodies 120, and the steam exiting the upper mold bodies 160, along with the contaminants, can reach the molded parts 200 that are resting on the lower mold bodies 120. The smaller the distance, the lower the escape of contaminants.

The molded parts 200 contaminated during cleaning can subsequently be discharged as scrap.

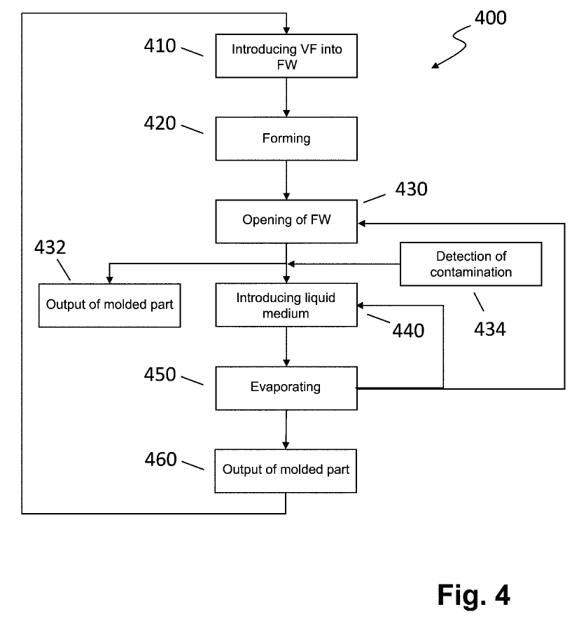

FIG. 4 shows a schematic representation of a method 400 for molding molded parts 200 and cleaning a molding tool 100 with reference to the preceding embodiments.

The method 400 for molding molded parts 200 requires the provision of a moldable fibrous material or a preformed preform (VF) made of fibrous material. This is followed by an introduction 410 of the fibrous material or of preforms (VF) into a molding tool 100 (FW). For this purpose, the molding tool 100 is in an open state, as shown schematically in FIG. 1. The molding tool 100 or the tool halves (tool bodies 110, 150 and mold bodies 120, 160) are heated in order to bring the shaping surfaces 124 of the mold bodies 120, 160 to the required molding temperature for the molding process to bond the fibers.

Subsequently, the molding tool 100 is closed and the preforms (VF) are pressed in molding cavities between the shaping surfaces 124 under high pressure and thermal influence, where a molding 420 of mold bodies 200 is carried out. During molding 420, water vapor generated is discharged via openings 126 and channels 127.

After molding 420, the molding tool 100 is opened 430. In a normal molding sequence, the molded parts 200 are subsequently transferred (432) out of the molding tool 100 and supplied to further processing.

In accordance with the method of FIG. 4, cleaning is carried out after a detection 434 or after reaching a specifiable number of molding operations, where for this purpose an introduction 440 of a liquid medium (e.g., water) is carried out, as described with reference to FIGS. 1 to 3. The mold bodies 200 remain in the molding tool 100. For example, the mold bodies 200 remain on a lower molding tool half.

Due to the prevailing temperature in the molding tool 100, the liquid medium is introduced and evaporates 450, flowing through the channels 127 and openings 126 of the mold bodies 120, and in the process removing impurities and deposits. Subsequently, the cleaning process can be terminated if only the mold bodies 120 of one tool body 110 are to be cleaned.

In further embodiments, cleaning of an upper molding tool half can subsequently be carried out, where for this purpose the opening 430 for cleaning can be smaller than the displacement for removing molded parts 200. Thus, after cleaning a lower molding tool half, cleaning of an upper molding tool half can be carried out, where no molded parts 200 directly contact the shaping surfaces of the upper molding tool half to serve for adsorption of contaminants. However, the small displacement of the molding tool halves provides the possibility of absorbing contaminants.

In further embodiments, the cleaning steps for a lower and an upper molding tool half can be performed alternately. In further embodiments, the introduction of a liquid medium can be carried out in a pulsed manner and/or under pressure.

After cleaning, the output 460 of molded parts 200 from the cleaning process is carried out, which can be disposed of as described above, since contaminants (fibrous materials, lime, etc.) are deposited on the surfaces of the molded parts 200. In other embodiments, disposal may be unnecessary if there are only small deposits.

After cleaning, the molding process for producing molded parts 200 can be continued directly thereafter, where no start-up times for heating the molding tool 100 or installation times for cleaning components or components of the molding tool 100 itself need to be taken into account.

The detection of contamination can be carried out based on experience regarding the degree of contamination, a reduction in discharge performance when discharging water vapor during pressing, a temperature decrease/increase and a visible and/or perceptible deterioration of the quality and condition of molded parts 200. Measurement and monitoring systems can be used for this purpose.

In further embodiments, the introduction of the liquid medium can be carried out with the aid of devices that introduce the liquid directly at selected points in the molding tool 100. For example, spray lances can be used for this purpose. This prevents the medium from being introduced too early or at unsuitable points, such that the spreading of steam is not optimal. Preferably, the steam can emerge from the openings 126 of a plurality of mold bodies 120 in a definable sequence (for example, from the center outward).

### List of reference signs

100 Molding tool

110 Tool body (first mold half)

112 Collecting channel

114 Inlet region

116 Valve

118 Valve

120 Mold body

122 Block

124 Shaping surface

126 Opening

127 Channel

150 Tool body (second mold half)

160 Mold body

200 Molded part

400 Method

410-460 Method steps

1. A method for cleaning molding tools for molding fibrous materials, wherein a molding tool has openings in at least one region of a shaping surface, the openings
being connected to channels for discharging water vapor exiting during a molding process under pressure and heat input, wherein the openings and channels for discharging water vapor are provided in a discharge direction out of the molding tool,
wherein, for cleaning the openings and channels, a medium in liquid form is introduced into at least one channel of the molding tool counter to the discharge direction when
the molding tool has a minimum temperature, and wherein the introduced liquid medium changes into a gaseous state by contact with the molding tool and exits from the channels and openings counter to the discharge direction.

2. The method according to claim 1, wherein the minimum temperature is in a temperature range of 90 - 300 °C.

3. The method according to claim 1, wherein process heat of the molding process for molding fibrous materials is used for a change of an aggregate state of the liquid medium.

4. The method according to claim 1, wherein the molding tool is heated to the minimum temperature by a heating device for the molding tool.

5. The method according to claim 1, wherein water is introduced as the liquid medium.

6. The method according to claim 1, wherein the liquid medium is introduced under a pressure of 1 to 200 bar.

7. The method according to claim 1, wherein the liquid medium is introduced in a pulsed manner.

8. The method according to claim 1, wherein the liquid medium is supplied in a temperature range of 5 - 50°C.

9. The method according to claim 1, wherein the liquid medium includes at least two different constituents.

10. The method according to claim 1, wherein the molding tool has at least two mold halves that are movable relative to one another, and the at least two mold halves each have at least one shaping surface that, in a closed state, forms a cavity, wherein the introduction of the liquid medium is carried out when the at least two mold halves are open.

11. The method according to claim 10, wherein the introduction of the liquid medium is carried out after the molding of fibrous material in the cavity.

12. The method according to claim 11, wherein, in a cleaning cycle after molding a fibrous material into a molded part, the molding tool is initially opened by relative displacement of the at least two mold halves, and the molded part is held by suction via the openings and channels of a first mold half, and cleaning by the gaseous medium is carried out via the openings and channels of a second mold half, and the molding tool is subsequently closed again, wherein the molded part is transferred by suction to the second mold half, and the molding tool is subsequently opened, wherein cleaning of the channels and openings of the first mold half is then carried out via the gaseous medium.

13. The method according to claim 10, wherein cleaning is carried out alternately via the openings and channels of the two at least mold halves movable relative to one another.

14. The method according to claim 1, wherein the introduction of the liquid medium is carried out regularly or according to a detected contamination of the molding tool.

15. The method according to claim 1, wherein the molding tool has at least one tool body and at least one mold body connected to the at least one tool body, wherein the at least one mold body has a shaping surface with openings and channels for discharging water vapor, and wherein the liquid medium is introduced into at least one collecting channel of the at least one tool body that is connected to the channels of the at least one mold body.

16. The method according to claim 15, wherein the at least one tool body is heated.

17. The method according to claim 1, further comprising controlling an amount of the liquid medium introduced to the molding tool to inhibit cooling of the molding tool below a specified temperature.

18. The method according to claim 17, wherein the specified temperature is a minimum temperature experienced during molding fibrous materials using the molding tool.

19. The method according to claim 1, wherein the introduction of the liquid medium is carried out in response to determining one or more of: a specified pressure change of a negative pressure for discharging water vapor during pressing using the molding tool, a specified temperature change of the molding tool, or a change of moisture in molded parts.

20. A molding tool for molding molded parts from fibrous material, wherein the molding tool has two mold halves that are movable relative to one another, wherein the mold halves in each case have at least one mold body with a shaping surface, and the shaping surface has openings that are connected to channels in the mold body, and wherein the molding tool has a device for direct or indirect introduction of a liquid medium into the channels of at least one mold body to clean the molding tool according to the method of claim 1.
